(19) United States
(12) Patent Application Publication
(10) Pub. No.: US 2025/0179339 A1
(43) Pub. Date: Jun. 5, 2025

(54) HIGH TEMPERATURE STABLE CURABLE BONDING COMPOSITIONS

(71) Applicant: 3M INNOVATIVE PROPERTIES COMPANY, St. Paul, MN (US)

(72) Inventors: Naichao Li, Woodbury, MN (US); Ralph R. Roberts, Oakdale, MN (US); Kazuki Noda, Tokyo (JP)

(21) Appl. No.: 18/842,634

(22) PCT Filed: Feb. 22, 2023
(86) PCT No.: PCT/IB2023/051630

§ 371 Date: Aug. 29, 2024

Related U.S. Application Data
(60) Provisional application No. 63/318,055, filed on Mar. 9, 2022.

(51) Int. Cl. C09J 179/08; C09J 183/08

(52) U.S. Cl. CPC C09J 179/08; C09J 183/08; C09J 2479/08; C09J 2483/00

(57) ABSTRACT

Curable bonding compositions include a free radically polymerizable bis-maleimide resin, a polymerizable siloxane-based release agent, and an optional thermal or ultraviolet free radical initiator. The curable composition is a coatable composition. Upon curing, the cured composition is high temperature stable as measured by isothermal TGA (Thermal Gravimetric Analysis) having a weight loss of 2.5% or less at a temperature of at least 300° C. for 1 hour and remains releasable by peeling after exposure to at least 300° C. for 1 hour.

### SUMMARY

Disclosed herein are high temperature stable curable bonding compositions, laminate bodies prepared with the curable bonding compositions, and methods for preparing laminate bodies.

In some embodiments, the curable bonding composition comprises at least one free radically polymerizable bis-maleimide resin, at least one polymerizable siloxane-based release agent, and an optional thermal or ultraviolet free radical initiator. The curable composition is a coatable composition, either 100% solids or solvent-diluted. Upon curing, the cured composition is high temperature stable as measured by isothermal TGA (Thermal Gravimetric Analysis) having a weight loss of 2.5% or less at a temperature of at least 300° C. for 1 hour and remains releasable by peeling after exposure to at least 300° C. for 1 hour.

Also disclosed herein are laminate bodies. In some embodiments, the laminate body comprises a substrate to be processed, a joining layer in contact with the substrate, a photothermal conversion layer comprising a light absorbing agent and a heat decomposable material disposed beneath the joining layer, and a light transmitting support disposed beneath the photothermal conversion layer. The joining layer is the cured bonding composition described above.

Also disclosed are methods for preparing laminate bodies. In some embodiments, the method comprises coating on a light transmitting support a photothermal conversion layer precursor containing a light absorbing agent and a heat decomposable material or a monomer or oligomer as a precursor of a heat decomposable material, drying to solidify or curing the photothermal conversion layer precursor to form a photothermal conversion layer on the light transmitting support, applying a curable bonding composition to a substrate to be processed or to the photothermal conversion layer to form a joining layer, and joining the substrate to be processed and the photothermal conversion layer through the joining layer under reduced pressure to form a laminate body. The joining layer is the cured bonding composition described above.

### BRIEF DESCRIPTION OF THE DRAWINGS

The present application may be more completely understood in consideration of the following detailed description of various embodiments of the disclosure in connection with the accompanying drawings.

FIG. 1A is a cross sectional view of an embodiment of a laminate body of this disclosure.

FIG. 1B is a cross sectional view of an embodiment of another laminate body of this disclosure.

In the following description of the illustrated embodiments, reference is made to the accompanying drawings, in which is shown by way of illustration, various embodiments in which the disclosure may be practiced. It is to be understood that the embodiments may be utilized and structural changes may be made without departing from the scope of the present disclosure. The figures are not necessarily to scale. Like numbers used in the FIGURES refer to like components. However, it will be understood that the use of a number to refer to a component in a given figure is not intended to limit the component in another figure labeled with the same number.

### DETAILED DESCRIPTION

The use of adhesives and bonding compositions is increasing in a wide range of applications. The most common use for adhesives is in bonding, that is to say adhering one substrate to another substrate. Often the adhesive is designed to adhere permanently or at least for a long time period, and the adhesive is incorporated into the final article. Examples range from optical adhesives that bind together layers of film for use on a display screen to structural adhesives that hold bumpers onto cars.

There is however a specialized class of adhesive articles that are not designed to adhere together articles permanently or for a long time, but rather are described as “processing” articles. By this it is meant that the adhesive is meant to temporarily hold together components or provide a temporary protective layer for components so that a process or series of processes can be carried out. After the processing steps, the adhesive article is removed. Typically, it is desirable that the removal of the adhesive article leaves behind no residue or residue that is easily removable. A simplistic example of an adhesive processing article is masking tape. In one wishes to paint a wall without getting paint on the base boards, one applies masking tape to the base boards at the wall/base board interface. The wall is then painted and the masking tape functions to prevent paint from getting on the base board. The masking tape is removed, leaving behind no residue.

Current industrial needs, especially in the electronic and optical industries, as well as in the manufacture of consumer goods and other articles, have requirements much more complex and specialized than the simplistic example presented above. An Illustrative example is the process of semiconductor wafers. The wafers are typically small articles to which a variety of processing steps are carried out. In many instances a processing adhesive is used to hold the wafer while these processes are carried out. Many of these steps involve vigorous physical processes such as polishing and grinding, as well as exposure to elevated temperatures. Therefore, it is necessary to have a processing adhesive that will hold the wafer firmly in place during these steps. Upon completion of the processing steps, the wafer must be removable from the processing article. Such processing adhesives have a variety of requirements, requirements that are apparently contradictory such as holding strongly and yet being easily removed.

Disclosed herein are curable bonding compositions that comprise at least one free radically polymerizable bis-maleimide resin, at least one polymerizable siloxane-based release agent, and an optional thermal or ultraviolet free radical initiator. The curable composition is a coatable composition, either 100% solids or solvent-diluted, and upon curing, the cured composition is high temperature stable as measured by isothermal TGA (Thermal Gravimetric Analysis) having a weight loss of 2.5% or less at a temperature of at least 300° C. for 1 hour and remains releasable by peeling after exposure to at least 300° C. for 1 hour.

Also disclosed are laminate bodies comprising a substrate to be processed, a joining layer in contact with the substrate the joining layer comprising the cured curable bonding composition described above, a photothermal conversion layer comprising a light absorbing agent and a heat decomposable material disposed beneath the joining layer, and a light transmitting support disposed beneath the photothermal conversion layer. Methods for preparing such laminate bodies are also disclosed.

The term “adhesive” and “bonding composition” are used interchangeably and refer to polymeric compositions useful in bonding.

The term “curing” as used herein refers to polymerization. The term curing is used broadly in the art and often refers to crosslinking or vulcanization. In this disclosure, curing simply means polymerization is not synonymous with crosslinking, but may include crosslinking.

The terms “siloxane” and “siloxane-based” as used herein refer to polymers or units of polymers that contain siloxane units. The terms silicone or siloxane are used interchangeably and refer to units with dialkyl or diaryl siloxane (—SiR₂O—) repeating units.

The term “adjacent” as used herein when referring to two layers means that the two layers are in proximity with one another with no intervening open space between them. They may be in direct contact with one another (e.g. laminated together) or there may be intervening layers.

The terms “polymer” and “macromolecule” are used herein consistent with their common usage in chemistry. Polymers and macromolecules are composed of many repeated subunits. As used herein, the term “macromolecule” is used to describe a group attached to a monomer that has multiple repeating units. The term “polymer” is used to describe the resultant material formed from a polymerization reaction.

The term “100% solids composition” refers to a composition that is essentially free of solvent or is solvent free.

The term “solvent-diluted” refers to a composition that has added solvent to reduce the viscosity and increase the coatability of a composition.

The term “alkyl” refers to a monovalent group that is a radical of an alkane, which is a saturated hydrocarbon. The alkyl can be linear, branched, cyclic, or combinations thereof and typically has 1 to 20 carbon atoms. In some embodiments, the alkyl group contains 1 to 18, 1 to 12, 1 to 10, 1 to 8, 1 to 6, or 1 to 4 carbon atoms. Examples of alkyl groups include, but are not limited to, methyl, ethyl, n-propyl, isopropyl, n-butyl, isobutyl, tert-butyl, n-pentyl, n-hexyl, cyclohexyl, n-heptyl, n-octyl, and ethylhexyl.

The term “aryl” refers to a monovalent group that is aromatic and carbocyclic. The aryl can have one to five rings that are connected to or fused to the aromatic ring. The other ring structures can be aromatic, non-aromatic, or combinations thereof. Examples of aryl groups include, but are not limited to, phenyl, biphenyl, terphenyl, anthryl, naphthyl, acenaphthyl, anthraquinonyl, phenanthryl, anthracenyl, pyrenyl, perylenyl, and fluorenyl.

The term “alkylene” refers to a divalent group that is a radical of an alkane. The alkylene can be straight-chained, branched, cyclic, or combinations thereof. The alkylene often has 1 to 20 carbon atoms. In some embodiments, the alkylene contains 1 to 18, 1 to 12, 1 to 10, 1 to 8, 1 to 6, or 1 to 4 carbon atoms. The radical centers of the alkylene can be on the same carbon atom (i.e., an alkylidene) or on different carbon atoms.

The terms “free radically polymerizable” and “ethylenically unsaturated” are used interchangeably and refer to a reactive group which contains a carbon-carbon double bond which is able to be polymerized via a free radical polymerization mechanism.

Disclosed herein are curable bonding compositions that comprise at least one free radically polymerizable bis-maleimide resin, at least one polymerizable siloxane-based release agent, and an optional thermal or ultraviolet free radical initiator. The curable composition is a coatable 100% solids composition, and upon curing, the cured composition is high temperature stable as measured by isothermal TGA (Thermal Gravimetric Analysis) having a weight loss of 2.5% or less at a temperature of at least 300° C. for 1 hour and remains releasable by peeling after exposure to at least 300° C. for 1 hour.

The curable composition comprises at least one free radically polymerizable bis-maleimide resin. A wide range of free radically polymerizable bis-maleimide resins are suitable. In some embodiments, the free radically polymerizable bis-maleimide resin comprises at least one compound of Structure 1:

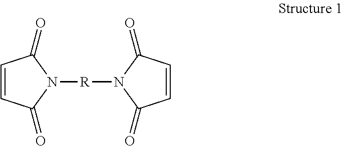

wherein R comprises a divalent linking group containing an alkylene group, an aromatic group, a heteroatom-containing group, a siloxane group, one or more polyimide linkages, or a combination thereof.

A wide range of free radically polymerizable bis-maleimide resins are commercially available. Examples include BMI-689, BMI-1500, BMI-1700, BMI-3000, and BMI-5000 from Designer Molecules. Exemplary structures are shown below as (a)-(d).

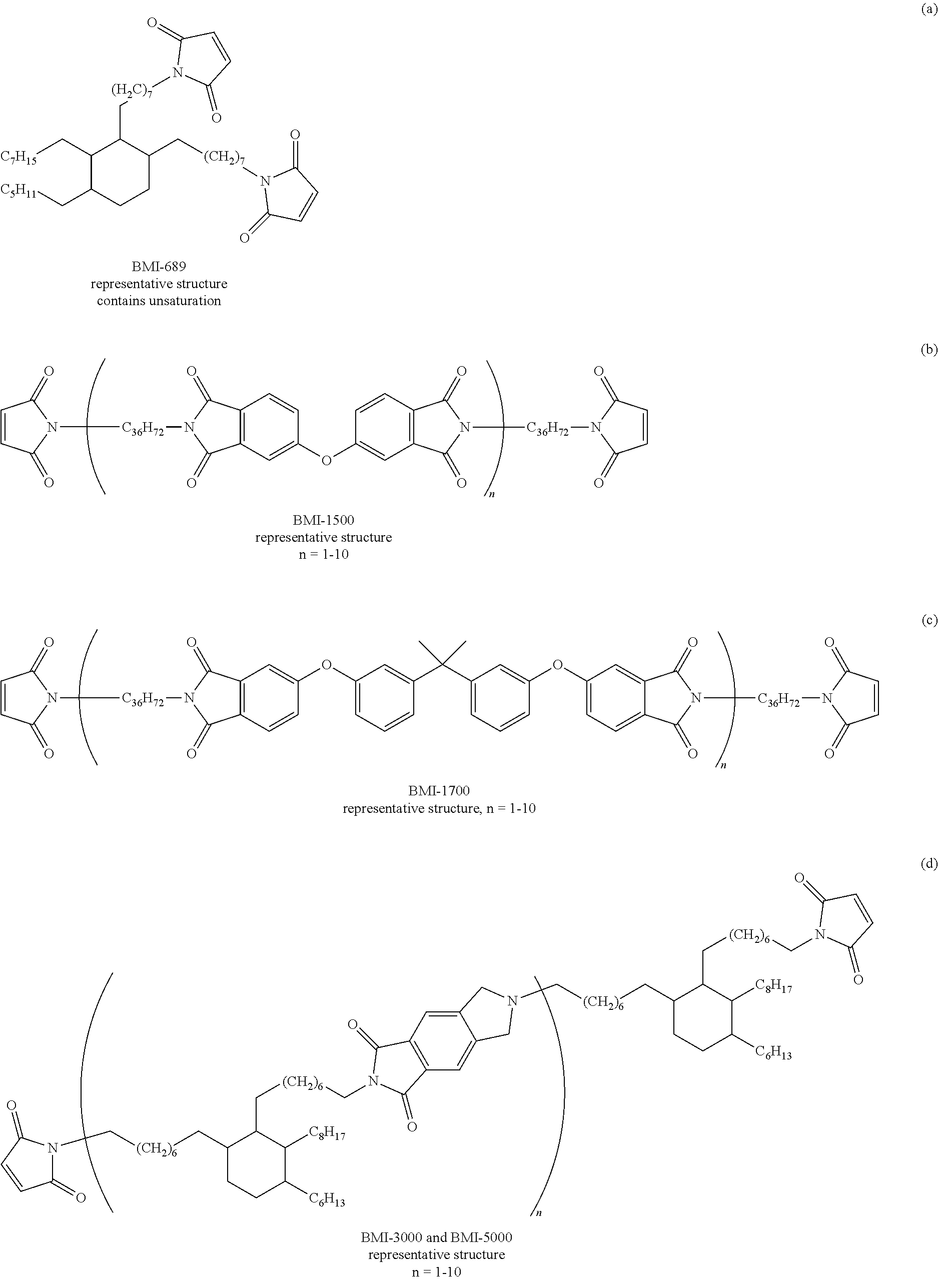

In some embodiments, the free radically polymerizable bis-maleimide resin comprises at least one compound of Structure 1, wherein R comprises an oligomeric group containing polyimide groups.

In some embodiments, the free radically polymerizable bis-maleimide resin comprises at least one compound of Structure 1, wherein R comprises a siloxane-based group. One advantage of this type of bis-maleimide resin is that the presence of the siloxane group can aid in the releasability of the cured bonding composition. An example of such a resin includes Compound 1 shown below as is described in U.S. Pat. No. 4,923,997:

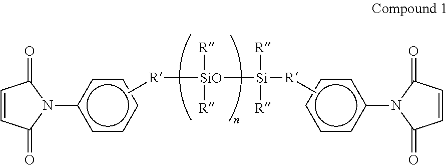

In Compound 1, R′ is an alkenylene or alkylene group, R″ are independently hydrocarbon or halohydrocarbon groups, and n is an integer.

In many embodiments, the at least one free radically polymerizable bis-maleimide resin comprises a mixture of bis-maleimides. The use of a combination of resins provides flexibility in controlling the viscosity of the coatable 100% solids bonding composition, as well the ability to control the final properties of the cured coatable compositions.

The curable bonding composition also comprises at least one polymerizable siloxane-based release agent, meaning that the siloxane-based release agent is co-polymerizable with the bis-maleimide resin or combination of resins described above. In some embodiments, the at least one siloxane-based release agent comprises a siloxane (meth)acrylate, a siloxane hydride, or a siloxane maleimide.

A wide variety of siloxane (meth)acrylates are commercially available under the trade names TEGO Rad 2300, TEGO Rad 2250, TEGO Rad 2100, and TEGO Rad 2500 from Evonik Industries. These compounds are similar, having the general structure of Compound 2 shown below:

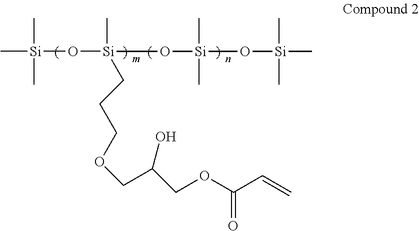

For TEGO Rad 2300, m is 1-5, and n is such that the ratio of acrylate groups to methyl groups is 1:20 to 1:50. For TEGO Rad 2100 and TEGO Rad 2500, n ranges from 10-20 and m is 0.5-5. Another commercially available siloxane (meth)acrylate is EBECRYL 350, a silicone diacrylate from Allnex.

Examples of siloxane hydrides include HMS-301 Methylhydrosiloxane-Dimethylsiloxane Copolymers, Trimethylsiloxy terminated, a silicone hydride from Gelest.

Examples of siloxane maleimides include, for example Compound 1 shown above.

Free radical curing of the curable composition can be effected by exposure to an electron beam (E-beam) or to gamma ray radiation. The use of an E-beam or gamma ray radiation does not require the use of an initiator. A variety of procedures for E-beam and gamma ray curing are well-known. The cure depends on the specific equipment used, and those skilled in the art can define a dose calibration model for the specific equipment, geometry, and line speed, as well as other well understood process parameters.

Commercially available electron beam generating equipment is readily available. For the examples described herein, the radiation processing was performed on a Model CB-300 electron beam generating apparatus (available from Energy Sciences, Inc. (Wilmington, MA). Commercially available gamma irradiation equipment includes equipment often used for gamma irradiation sterilization of products for medical applications.

In some embodiments, the curable composition may additionally comprise at least one initiator. The at least one initiator is a free radical initiator. The initiator may be a thermal initiator or a photoinitiator. In many embodiments the initiator is a thermal initiator. Thermal initiators are species which generate free radicals upon heating. Many possible thermal free radical initiators are known in the art of vinyl monomer polymerization and may be used. Typical thermal free radical polymerization initiators which are useful herein are organic peroxides, organic hydroperoxides, and azo-group initiators which produce free radicals. Useful organic peroxides include but are not limited to compounds such as benzoyl peroxide, di-t-amyl peroxide, t-butyl peroxy benzoate, and di-cumyl peroxide. Useful organic hydroperoxides include but are not limited to compounds such as t-amyl hydroperoxide and t-butyl hydroperoxide. Useful azo-group initiators include but are not limited to the VAZO compounds manufactured by DuPont, such as VAZO 52 (2,2′-azobis(2,4-dimethylpentanenitrile)), VAZO 64 (2,2′-azobis(2-methylpropanenitrile)), VAZO 67 (2,2′-azobis(2-methylbutanenitrile)), and VAZO 88 (2,2′-azobis(cyclohexanecarbonitrile)). Additional commercially available thermal initiators include, for example, LUPERSOL 130 (2,5-dimethyl-2,5-Di-(t-butylperoxy)hexyne-3) available from Sigma-Aldrich, St. Louis, MO, and LUPEROX 101 (2,5-dimethyl-2,5-di-(tert-butylperoxoxy)hexane) and LUPEROX 231 (1,1-Bis(tertbutylperoxide)-3,3,5-trimethylcyclohexane) available from Arkema, Inc., King of Prussia, PA, and UN3114 (BCHPC) (Di(4-(tertbutylcyclohexyl) peroxydicarbonate) available from United Initiators.

In some embodiments, the initiator may comprise a photoinitiator, meaning that the initiator is activated by light, typically ultraviolet (UV) light. Examples of suitable free radical photoinitiators include DAROCURE 4265, IRGACURE 651, IRGACURE 1173, IRGACURE 819, LUCIRIN TPO, LUCIRIN TPO-L, commercially available from BASF, Charlotte, NC, and OMNIRAD 819 (Bis(2,4,6-trimethylbenzoyl)-phenyl phosphine oxide) available from IGM Resins.

A sufficient amount of initiator typically is used to carry the polymerization to the desired temperature and conversion. The total photoinitiator amount used is typically in the range of about 0.01 weight % to about 5.0 weight % or in the range of about 0.1 weight % to about 2.0 weight % based on the total monomer content. The total thermal initiator amount used is typically in the range of about 0.1 weight % to about 5.0 weight % or in the range of about 0.5 weight % to about 4.0 weight % based on the total monomer content.

Many embodiments of the curable bonding composition are 100% solids. If desired, especially if the viscosity makes coating difficult or too slow, the curable composition may be solvent-diluted, that is the curable bonding composition further comprises a solvent. A wide variety of solvents are suitable, but ethers and acetates are particularly suitable. Examples of suitable solvents include PGMEA (propyl glycol monomethyl ether acetate) and PGME (propyl glycol monomethyl ether).

Typically, prior to curing the solvent is removed from the coated composition by drying. Drying can be accelerated by exposure to elevated temperatures. If a solvent is used and is dried prior to curing, the temperature of drying is less than the activation temperature for any thermal initiator, if such an initiator is used.

As mentioned above, the bonding compositions have a variety of properties that make them suitable for use in a wide range of processes. Among the desirable properties is that the cured composition is high temperature stable as measured by isothermal TGA (Thermal Gravimetric Analysis) having a weight loss of 2.5% or less at a temperature of at least 300° C. for 1 hour. This is desirable because many processes involve exposing the cured adhesive to temperatures of least 300° C. for 1 hour. The elevated temperature stability is further characterized in that the cured adhesive remains releasable by peeling after exposure to at least 300° C. for 1 hour.

While 300° C. is a quite extreme condition for the bonding composition to endure, in some embodiments the conditions are even more extreme. For example, in some embodiments, the cured composition is high temperature stable as measured by isothermal TGA (Thermal Gravimetric Analysis) having a weight loss of 4.5% or less at a temperature of at least 350° C. for 1 hour. This stability is further characterized in that the cured adhesive composition remains releasable by peeling or by chemical solvent cleaning after exposure to at least 350° C. for 1 hour. In this even more extreme set of conditions, some residue of the cured adhesive composition may be left behind, requiring the use of chemical solvent cleaning in addition to removal by peeling.

Also disclosed are laminate bodies comprising a substrate to be processed, a joining layer in contact with the substrate the joining layer comprising the cured curable bonding composition described above, a photothermal conversion layer comprising a light absorbing agent and a heat decomposable material disposed beneath the joining layer, and a light transmitting support disposed beneath the photothermal conversion layer. Methods for preparing such laminate bodies and the use of such laminates to process, for example wafers, is discussed in U.S. Pat. No. 7,534,498.

The current bonding compositions are suitable for use in the apparatus discussed in U.S. Pat. No. 7,534,498 using the methods disclosed therein. The bonding compositions are described in detail above and comprise at least one free radically polymerizable bis-maleimide resin, at least one polymerizable siloxane-based release agent, and an optional thermal or ultraviolet free radical initiator. As described above the current bonding compositions are particularly suitable for use because the curable composition is a coatable 100% solids composition, and upon curing, the cured composition is high temperature stable as measured by isothermal TGA (Thermal Gravimetric Analysis) having a weight loss of 2.5% or less at a temperature of at least 300° C. for 1 hour and remains releasable by peeling after exposure to at least 300° C. for 1 hour.

A wide variety of substrates to be processed are suitable. In many embodiments, the substrate is a brittle material. Examples of brittle materials include semiconductor wafers such as silicon and gallium arsenide, as well as rock crystal wafers, sapphire and glass.

The laminate also comprises a photothermal conversion layer disposed beneath the joining layer described above. The photothermal conversion layer comprises a light absorbing agent and a heat decomposable material. Radiation energy applied to the photothermal conversion layer in the form of a laser beam or the like is absorbed by the light absorbing agent and converted into heat energy. The heat energy generated abruptly elevates the temperature of the photothermal conversion layer and the temperature reaches the thermal decomposition temperature of the heat decomposable material in the photothermal conversion layer resulting in heat decomposition of the material. The gas generated by the heat decomposition is believed to form a void layer (such as air space) in the photothermal conversion layer and divide the photothermal conversion layer into two parts, whereby the support and the substrate are separated.

A wide range of materials are suitable for use in the photothermal conversion layer. In some embodiments, the light absorbing agent comprises carbon black, graphite powder, microparticle metal powders such as iron, aluminum, copper, nickel, cobalt, manganese, chromium, zinc and tellurium, metal oxide powders such as black titanium oxide, or a dye or pigment. In some embodiments, the light absorbing agent is carbon black and the total amount of carbon black and transparent filler in the photothermal conversion layer is from 5 to 70 vol %, based on the volume of the photothermal conversion layer.

A wide range of heat decomposable materials are suitable including the heat decomposable resins described in U.S. Pat. No. 7,534,498.

In some embodiments, the photothermal conversion layer further comprises a transparent filler. The transparent filler acts to prevent the re-adhesion of the photothermal conversion layer once it is separated due to the formation of a void layer as a result of the thermal decomposition of the heat decomposable material. Examples of suitable transparent fillers include silica, talc and barium sulfate. In some embodiments, the light absorbing agent is carbon black and the total amount of carbon black and transparent filler in the photothermal conversion layer is 80% or more of the filler volume concentration.

The laminate also comprises a light transmitting support. A wide range of light transmitting supports are suitable. The light transmitting support is a material that transmits light, such as laser light and at the same time provides a surface that keeps the substrate to be processed in a flat state and does not cause the substrate to break during processing. A particularly suitable light transmitting support is glass.

The laminate may also comprise additional optional layers. In some embodiments, the laminate further comprises a first intermediate layer between the joining layer and the photothermal conversion layer. Examples of suitable first intermediate layers include multilayer optical films. The laminate may also include a second intermediate layer, where the second intermediate layer is located between the photothermal conversion layer and the light transmitting support, and the second intermediate layer and the light transmitting support are joined through a second joining layer (typically an adhesive layer such as a pressure sensitive adhesive). Typically, the second intermediate layer is a coatable, curable material that is applied to the photothermal conversion layer and cured.

Also disclosed are methods for manufacturing a laminate body. In some embodiments, the method comprises coating on a light transmitting support a photothermal conversion layer precursor containing a light absorbing agent and a heat decomposable material or a monomer or oligomer as a precursor of a heat decomposable material, drying to solidify or curing the photothermal conversion layer precursor to form a photothermal conversion layer on the light transmitting support, applying a curable bonding composition to a substrate to be processed or to the photothermal conversion layer to form a joining layer, wherein the curable bonding composition has been described in detail above, and joining the substrate to be processed and the photothermal conversion layer through the joining layer under reduced pressure to form a laminate body.

As mentioned above, in some embodiments, the curable composition is a coatable 100% solids composition, and upon curing, the cured composition is high temperature stable as measured by isothermal TGA (Thermal Gravimetric Analysis) having a weight loss of 2.5% or less at a temperature of at least 300° C. for 1 hour and remains releasable by peeling after exposure to at least 300° C. for 1 hour. In other embodiments, the curable composition, upon curing, the cured bonding composition remains releasable by peeling or by chemical solvent cleaning after exposure to at least 350° C. for 1 hour.

Processing steps that utilize the laminate bodies of this disclosure are described, for example, in U.S. Pat. No. 7,534,498.

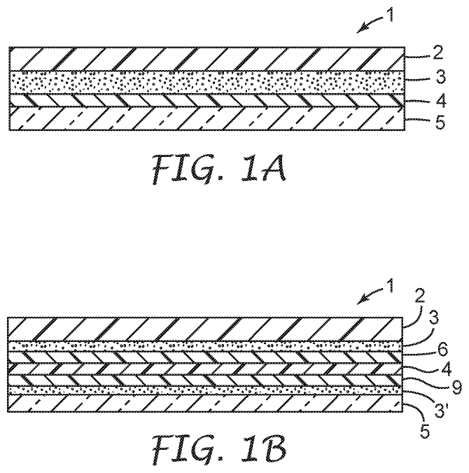

The disclosure may be more fully understood by reference to the FIGURES. The FIGURES show cross-sectional views of embodiments of laminate bodies of this disclosure. FIG. 1A shows laminate body 1 comprising substrate to be processed 2, cured joining layer 3, photochemical conversion layer 4, and light transmitting support 5, laminated in that order. Each of these layers is discussed in detail above.

FIG. 1B shows an alternative embodiment of laminate body 1, comprising substrate to be processed 2, cured joining layer 3, first intermediate layer 6, photochemical conversion layer 4, second intermediate layer 9, second joining layer 3, and light transmitting support 5, laminated in that order. Each of these layers is discussed in detail above.

### Examples

These examples are merely for illustrative purposes only and are not meant to be limiting on the scope of the appended claims. All parts, percentages, ratios, etc. in the examples and the rest of the specification are by weight, unless noted otherwise. The following abbreviations are used: cm=centimeters; RPM=revolutions per minute; kg=kilograms; cPs=centiPoise; mi=minutes; hr=hour; m=milliJoules.

TABLE of Abbreviations

| Abbreviation | |
|---|---|
| or Trade | |
| Designation | Description |
| Mon-1 | Monomer-1, Bismaleimide, commercially available as BMI-689 from |
| | Designer Molecules, with a viscosity of 1000-2000 cPS at 25° C. |
| Mon-2 | Monomer-2, Bismaleimide, commercially available as BMI-1700 from |
| | Designer Molecules, with a viscosity of 20,000-50,000 cPS at 60° C. |
| TI | Thermal Initiator, Di(4-tert-butylcyclohexyl)peroxydicarbonate |
| | commercially available as UN3114 (BCHPC) from United Initiators |
| PI | Photo Initiator, Bis(2,4,6-trimethylbenzoyl)-phenyl phosphine oxide |
| | commercially available as OMNIRAD 819 form IGM Resins |
| RA-1 | Release Agent-1, a silicone acrylate commercially available as TEGO |
| | RAD 2300 from Evonik Industries |
| RA-2 | Release Agent-2, a silicone acrylate commercially available as TEGO |
| | RAD 2650 from Evonik Industries |
| RA-3 | Release Agent-3, a silicone acrylate commercially available as TEGO |
| | RAD 2800 from Evonik Industries |
| RA-4 | Release Agent-4, HMS-301 Methylhydrosiloxane - Dimethylsiloxane |
| | Copolymers, Trimethylsiloxy terminated, a silicone hydride from |
| | Gelest |
| RA-5 | Release Agent-5, EBECRYL 350, a silicone diacrylate from Allnex |
| Wafer | Silicon wafer, 100 mm diameter, mechanical grade, commercially |
| | available from University Wafer |

### Test Methods

### Thermogravimetric Analysis (TGA)

TGA analysis of adhesive samples was carried out under N₂ gas protection to determine the weight loss after 300 or 350° C. for 1 hr. The weight loss of adhesive samples at 300 or 350° C. for 1 hr was measured using TGA (954000.901) from TA instrument. The temperature ramp rate was 10° C./min.

### 90 Degree Peel Force Testing

The 90 degree peeling force of the adhesive was measured using Imass SP-2100 (Imass, Inc.). The testing conditions were: Load cell capacity: 5 kg; speed: 12 inches/min (30 cm/min); Delay: 2 second; Test time: 2 or 5 seconds, sample width: 0.5 inch (13 cm), peel force presented in Newtons.

### Examples

### Examples 1-6 and Comparative Examples CE1 and CE2

### Sample Preparation

### UV Cure Formulation Preparation:

Adhesive formulations were prepared using the components described in Table 1 below. The components were added to a light-blocking plastic mixing container. The mixture in the container was heated in an oven at 90° C. for 20 minutes. The mixture was hand mixed and mixed again using a vacuum high-speed mixer: DAC 800.2 VAC-P (FlackTek Inc, Landrum, SC) at 2000 rpm, vacuum 10 torr, for 3 minutes.

### Thermal Cure Formulation Preparation:

Adhesive formulations were prepared using the components (except the thermal initiator) described in Table 1 below. The components were added to a plastic mixing container. The mixture in the container was heated in an oven at 90° C. for 20 minutes. The mixture was hand mixed and mixed again using a vacuum high-speed mixer: DAC 800.2 VAC-P (FlackTek Inc, Landrum, SC) at 2000 rpm, vacuum 10 torr, for 3 minutes. After mixing and the mixture cooled down, the thermal initiator was added, hand mixed first then the high-speed mixing process was repeated again but at 1500 rpm.

### Spin Coating:

The adhesive was spin coated on a 100 mm diameter silicon wafer at a condition of: 1^{st}: 1200 rpm for 20 seconds; 2^{nd}: 2000 rpm for 40 seconds.

### UV or Thermal Curing:

The spin coated adhesive and wafer described above was either thermally (150-220° C. for 1-1.5 hr) or UV (2400 mJ/cm²) cured.

### Baking Process:

The cured adhesive and wafer described above was put on a hot plate (Model 10, Brewer science, Inc.) protected with N₂ gas followed by increasing the temperature to 300° C. with a ramp rate of 6° C./min, after baking at 300° C. for 1 hr, the hot plate temperature was cooled to room temperature.

### Testing

The formulations were tested for TGA weight loss and 90 degree peel adhesion (initial and after baking process). The results are presented in Table 2 below.

TABLE 1
Formulations and Data

| Example | PI | TI | Mon-1 | Mon-2 | RA-1 | RA-2 | RA-3 | RA-4 | RA-5 |
|---|---|---|---|---|---|---|---|---|---|
| CE1 | 0.0275 | | 4 | 1.5 | | | | | |
| 1 | 0.0275 | | 4 | 1.5 | 0.055 | | | | |
| 2 | 0.0275 | | 4 | 1.5 | | 0.055 | | | |
| 3 | 0.0275 | | 4 | 1.5 | | | 0.055 | | |
| 4 | 0.0275 | | 4 | 1.5 | | | | 0.055 | |
| 5 | 0.0275 | | 4 | 1.5 | | | | | 0.055 |
| CE2 | | 0.165 | 4 | 1.5 | | | | | |
| 6 | | 0.165 | 4 | 1.5 | 0.055 | | | | |

TABLE 2

| | | Peeling force, | Weight | Weight |
|---|---|---|---|---|
| | | after baking at | loss at | loss at |
| | Peeling force, | 300° C. for 1 hr, | 300° C. | 350° C. |
| Example | initial, Newton | Newton | for 1 hr, | for 1 hr |
| CE1 | 0.10 | Can't peel off | 1.6% | 3.3% |
| 1 | 0.01 | 0.23 | 1.9% | 3.7% |
| 2 | 0.07 | 0.34 | 1.7% | 3.5% |
| 3 | 0.05 | 0.32 | 1.8% | 3.3% |
| 4 | 0.06 | 0.36 | 1.9% | 3.9% |
| 5 | 0.01 | 0.33 | 1.9% | 3.8% |
| CE2 | Can't peel off | Can't peel off | 0.7% | 3.4% |
| 6 | 1.44 | 1.51 | 1.0% | 3.5% |

What is claimed is:

1. A curable bonding composition comprising:
at least one free radically polymerizable bis-maleimide resin;
at least one polymerizable siloxane-based release agent; and
an optional thermal or ultraviolet free radical initiator, wherein the curable composition is a coatable composition, either 100% solids or solvent-diluted, and wherein upon curing, the cured composition is high temperature stable as measured by isothermal TGA (Thermal Gravimetric Analysis) having a weight loss of 2.5% or less at a temperature of at least 300° C. for 1 hour, and remains releasable by peeling after exposure to at least 300° C. for 1 hour.

2. The curable bonding composition of claim 1, wherein the at least one free radically polymerizable bis-maleimide resin comprises a mixture of bis-maleimides.

3. The curable bonding composition of claim 1, wherein the at least one siloxane-based release agent comprises a siloxane (meth)acrylate, a siloxane hydride, or a siloxane maleimide.

4. The curable bonding composition of claim 1, wherein the free radically polymerizable bis-maleimide resin comprises at least one compound of Structure 1: 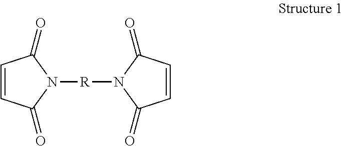
wherein R comprises a divalent linking group containing an alkylene group, an aromatic group, a heteroatom-containing group, a siloxane group, one or more polyimide linkages, or a combination thereof.

5. The curable bonding composition of claim 4, wherein R comprises an oligomeric group containing polyimide groups.

6. The curable bonding composition of claim 1, wherein the curable composition further comprises a solvent.

7. The curable bonding composition of claim 1, wherein upon curing, the cured composition is high temperature stable as measured by isothermal TGA (Thermal Gravimetric Analysis) having a weight loss of 4.5% or less at a temperature of at least 350° C. for 1 hour and remains releasable by peeling or by chemical solvent cleaning after exposure to at least 350° C. for 1 hour.

8. A laminate body comprising:
a substrate to be processed;
a joining layer in contact with the substrate, the joining layer comprising:
a cured curable bonding composition comprising:
at least one free radically polymerizable bis-maleimide resin;
at least one polymerizable siloxane-based release agent; and
an optional thermal or ultraviolet free radical initiator, wherein the curable composition is a coatable composition, either 100% solids or solvent-diluted,
and wherein upon curing, the cured composition is high temperature stable as
measured by isothermal TGA (Thermal Gravimetric Analysis) having a weight
loss of 2.5% or less at a temperature of at least 300° C. for 1 hour, and remains
releasable by peeling after exposure to at least 300° C. for 1 hour;
a photothermal conversion layer comprising a light absorbing agent and a heat decomposable material disposed beneath the joining layer; and
a light transmitting support disposed beneath the photothermal conversion layer.

9. The laminate body of claim 8, wherein the substrate is a brittle material.

10. The laminate body of claim 8, wherein the substrate is a silicon wafer.

11. The laminate body of claim 8, wherein the light absorbing agent comprises carbon black.

12. The laminate body of claim 8, wherein the photothermal conversion layer further comprises a transparent filler.

13. The laminate body of claim 12, wherein the light absorbing agent is carbon black and the total amount of carbon black and transparent filler in the photothermal conversion layer is from 5 to 70 vol %, based on the volume of the photothermal conversion layer.

14. The laminate body of claim 12, wherein the light absorbing agent is carbon black and the total amount of carbon black and transparent filler in the photothermal conversion layer is 80% or more of the filler volume concentration.

15. The laminate body of claim 8, wherein the support is glass.

16. The laminate body of claim 8, further comprising a first intermediate layer between the joining layer and the photothermal conversion layer.

17. The laminate body of claim 16, wherein the first intermediate layer is a multilayer optical film.

18. The laminate body of claim 16, wherein a second intermediate layer is provided between the photothermal conversion layer and the light transmitting support, and the second intermediate layer and the light transmitting support are joined through another joining layer.

19. A method for manufacturing a laminate body comprising:
coating on a light transmitting support a photothermal conversion layer precursor containing a light absorbing agent and a heat decomposable material or a monomer or oligomer as a precursor of a heat decomposable material;
drying to solidify or curing the photothermal conversion layer precursor to form a photothermal conversion layer on the light transmitting support;
applying a curable bonding composition to a substrate to be processed or to the photothermal conversion layer to form a joining layer, wherein the curable bonding composition comprises:
at least one free radically polymerizable bis-maleimide resin;
at least one polymerizable siloxane-based release agent; and
an optional thermal or ultraviolet free radical initiator, wherein the curable composition is a coatable composition, either 100% solids or solvent-diluted,
and wherein upon curing, the cured composition is high temperature stable as
measured by isothermal TGA (Thermal Gravimetric Analysis) having a weight
loss of 2.5% or less at a temperature of at least 300° C. for 1 hour, and remains
releasable by peeling after exposure to at least 300° C. for 1 hour; and
joining the substrate to be processed and the photothermal conversion layer through the joining layer under reduced pressure to form a laminate body.

20. The method of claim 19, wherein the cured bonding composition remains releasable by peeling or by chemical solvent cleaning after exposure to at least 350° C. for 1 hour.
